(19) United States
(12) Patent Application Publication
(10) Pub. No.: US 2020/0029112 A1
(43) Pub. Date: Jan. 23, 2020

(54) Request Identification Method and Apparatus

(71) Applicant: BEIJING YOUKU TECHNOLOGY CO., LTD., Beijing (CN)

(72) Inventor: Yuegang Xu, Hangzhou (CN)

(21) Appl. No.: 16/517,354

(22) Filed: Jul. 19, 2019

(30) Foreign Application Priority Data
Jul. 20, 2018 (CN) 2018108044044

(51) Int. Cl. H04N 21/254; H04N 21/24

(52) U.S. Cl. CPC H04N 21/2541; H04N 21/2408

(57) ABSTRACT

A method and an apparatus for identifying a request are disclosed. The method is applied in a target server. The method includes: determining whether associated information corresponding to first request information sent by a resource distribution server exists when receiving the first request information, wherein the first request information is determined by the resource distribution server based on a first resource request from a terminal; determining a request identification result based on the associated information and the first request information when the associated information exists; and returning the request identification result to the resource distribution server to cause the resource distribution server to perform an operation corresponding to the request identification result.

### CROSS REFERENCE TO RELATED PATENT APPLICATIONS

This application claims priority to Chinese Patent Application No. 201810804404.4, filed on Jul. 20, 2018 and entitled “Request Identification Method and Apparatus,” which is hereby incorporated by reference in its entirety.

### TECHNICAL FIELD

The present disclosure relates to the technical field of computers, and particularly, to request identification methods and apparatuses.

### BACKGROUND

A resource platform has a variety of resources for users to obtain. For example, a video platform has copyrighted exclusive drama shows for users to watch. In response to a resource request of a user, a resource platform can provide the user with various types of content requested thereby. However, some resource requests are abnormal requests, and inaccurate recognition thereof often leads to a relatively large waste of resources.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above, the present disclosure proposes methods and apparatuses for identifying a request, which can improve the accuracy of request identification.

According to an aspect of the present disclosure, a request identification method is provided, which is applied to a target server. The method includes:
determining whether associated information corresponding to first request information sent by a resource distribution server exists when receiving the first request information, wherein the first request information is determined by the resource distribution server based on a first resource request from a terminal;
determining a request identification result based on the associated information and the first request information when the associated information exists; and
returning the request identification result to the resource distribution server to cause the resource distribution server to perform an operation corresponding to the request identification result.

In implementations, the method further includes:
determining that the request identification result is an abnormal request when the associated information does not exist.

In implementations, the associated information includes second request information sent by a resource control server, wherein the second request information is determined by the resource control server according to a second resource request from the terminal, the first resource request is a request initiated by the terminal according to resource acquisition information, and the resource acquisition information is information returned by the resource control server for the second resource request.

Determining the request identification result based on the associated information and the first request information includes:
determining whether the first request information matches the second request information;
determining that the request identification result is an abnormal request when the first request information does not match the second request information.

In implementations, the second request information includes multiple parameters, wherein determining whether the first request information matches the second request information includes:
determining that the first request information does not match the second request information when at least one parameter mismatch exists.

In implementations, determining the request identification result based on the associated information and the first request information includes:
determining that the request identification result is an abnormal request if at least one piece of associated information does not match the first request information, when a plurality of pieces of associated information corresponding to the first request information exist.

In implementations, determining the request identification result based on the associated information and the first request information includes:
determining temporal order information of a plurality of pieces of associated information and the first request information when the plurality of pieces of associated information corresponding to the first request information exist; and
determining that the request identification result is an abnormal request when the temporal order information does not match a target temporal order.

In implementations, the parameters include at least one of information related to a resource, effective time information related to the second resource request, temporal order information related to the second resource request, user information related to the second resource request, and terminal information related to the second resource request.

In implementations, the resource acquisition information includes an address used to obtain a resource requested by the second resource request.

According to another aspect of the present disclosure, a request identification method is provided, which is applied to a resource distribution server. The method includes:
determining request information corresponding to a resource request when receiving the resource request from a terminal;
sending the request information to a target server, to cause the target server to determine a request identification result according to the request information; and
performing an operation corresponding to the request identification result in response to receiving the request identification result returned by the target server.

In implementations, the request identification result includes an abnormal request, wherein performing the operation corresponding to the request identification result includes:
starting an abnormality handling for the abnormal request.

In implementations, the request identification result includes a normal request, wherein performing the operation corresponding to the request identification result includes:
returning a resource corresponding to the resource request to the terminal.

According to another aspect of the present disclosure, a request identification apparatus is provided, which is applied in a target server. The apparatus includes:
a first determination module configured to determine whether associated information corresponding to first request information sent by a resource distribution server exists when receiving the first request information, wherein the first request information is determined by the resource distribution server based on a first resource request from a terminal;
a second determination module configured to determine a request identification result based on the associated information and the first request information when the associated information exists; and
an identification result sending module configured to return the request identification result to the resource distribution server to cause the resource distribution server to perform an operation corresponding to the request identification result.

In implementations, the apparatus further includes:
a third determination module configured to determine that the request identification result is an abnormal request when the associated information does not exist.

In implementations, the associated information includes second request information sent by a resource control server, wherein the second request information is determined by the resource control server according to a second resource request from the terminal. The first resource request is a request initiated by the terminal according to the resource acquisition information, wherein the resource acquisition information is information returned by the resource control server for the second resource request.

The second determination module includes:
a judgment sub-module configured to determine whether the first request information matches the second request information; and
a first determination sub-module configured to determine that the request identification result is an abnormal request when the first request information does not match the second request information.

In implementations, the second request information includes multiple parameters, wherein the judgment sub-module includes:
a second determination sub-module configured to determine that the first request information does not match the second request information when at least one parameter mismatch exists.

In implementations, the second determination module includes:
a third determination sub-module configured to determine that the request identification result is an abnormal request if at least one piece of associated information does not match the first request information, when a plurality of pieces of associated information corresponding to the first request information exist.

In implementations, the second determination module includes:
a fourth determination sub-module configured to determine temporal order information of a plurality of pieces of associated information and the first request information when the plurality of pieces of associated information corresponding to the first request information exist; and
a fifth determination sub-module configured to determine that the request identification result is an abnormal request when the temporal order information does not match a target temporal order.

In implementations, the parameters include at least one of: information related to a resource, effective time information related to the second resource request, temporal order information related to the second resource request, user information related to the second resource request, and terminal information related to the second resource request.

In implementations, the resource acquisition information includes an address used for obtaining a resource requested by the second resource request.

According to another aspect of the present disclosure, a request identification apparatus is provided, which is applied to a resource distribution server. The apparatus includes:
an information determination module configured to determine request information corresponding to a resource request when receiving the resource request from a terminal;
an information sending module configured to send the request information to a target server, to cause the target server to determine a request identification result according to the request information; and
an operation execution module configured to perform an operation corresponding to the request identification result when receiving the request identification result returned by the target server.

In implementations, the request identification result includes an abnormal request, wherein the operation execution module includes:
an abnormality handling initiation sub-module configured to initiate an abnormality handling for the abnormal request.

In implementations, the request identification result includes a normal request, wherein the operation execution module includes:
a resource sending sub-module configured to return a resource corresponding to the resource request to the terminal.

In accordance with another aspect of the present disclosure, a request identification apparatus is provided, which includes: a processor; and a memory storing processor-executable instructions, wherein the processor is configured to perform the above method(s).

According to another aspect of the present disclosure, a non-transitory computer readable storage medium having computer program instructions stored thereon, wherein the computer program instructions are executed by a processor to implement the request identification method(s).

In accordance with another aspect of the present disclosure, a request identification apparatus is provided, which includes: a processor; and a memory storing processor-executable instructions, wherein the processor is configured to perform the above method(s).

According to another aspect of the present disclosure, a non-transitory computer readable storage medium having computer program instructions stored thereon, wherein the computer program instructions are executed by a processor to implement the request identification method(s).

According to the embodiments of the present disclosure, in response to receiving first request information by a target server, a determination is made as to whether associated information corresponding to the first request information exists. When the associated information exists, a request identification result is determined according to the associated information and the first request information. Therefore, the accuracy of request identification is improved.

Other features and aspects of the present disclosure will become apparent based on a detailed description of exemplary embodiments as follows.

### BRIEF DESCRIPTION OF THE DRAWINGS

Accompanying drawings which are included in and constitute a part of the specification illustrate certain exemplary embodiments, features and aspects of the present disclosure in conjunction with the specification, and are used for describing the principles of the present disclosure.

FIG. 1 is a flowchart of a request identification method according to an exemplary embodiment.

FIG. 2 is a flowchart of a request identification method according to an exemplary embodiment.

FIG. 3 is a flowchart of a request identification method according to an exemplary embodiment.

FIG. 4 is a flowchart of a request identification method according to an exemplary embodiment.

FIG. 5 is a flowchart of a request identification method according to an exemplary embodiment.

FIG. 6 is a flowchart of a request identification method according to an exemplary embodiment.

FIG. 7 is a flowchart of a request identification method according to an exemplary embodiment.

FIG. 8 is a flowchart of a request identification method according to an exemplary embodiment.

FIG. 9 is a schematic diagram of an application scenario of a request identification method according to an exemplary embodiment.

FIG. 10 is a block diagram of a request identification apparatus according to an exemplary embodiment.

FIG. 11 is a block diagram of a request identification apparatus according to an exemplary embodiment.

FIG. 12 is a block diagram of a request identification apparatus according to an exemplary embodiment.

FIG. 13 is a block diagram of a request identification apparatus according to an exemplary embodiment.

FIG. 14 is a block diagram of a request identification apparatus according to an exemplary embodiment.

### DETAILED DESCRIPTION

Various exemplary embodiments, features, and aspects of the present disclosure are described in detail hereinafter with reference to the accompanying drawings. The same reference numerals in the drawings denote the same or similar elements. Although various aspects of the embodiments are illustrated in the accompanying drawings, the accompanying drawings are not necessarily drawn to scale unless indicated otherwise.

The word “exemplary” is used exclusively herein to mean “serving as an example, embodiment, or illustration.” Any embodiment described herein as “exemplary” is not necessarily to be construed as being preferred or better as compared to other embodiments.

In addition, a number of specific details are set forth in the Detailed Description as follows. One skilled in the art should understand that the present disclosure may be practiced without certain specific details. In some instances, methods, means, components, and circuits that are well known to one skilled in the art are not described in detail in order to emphasize the purpose of the present disclosure.

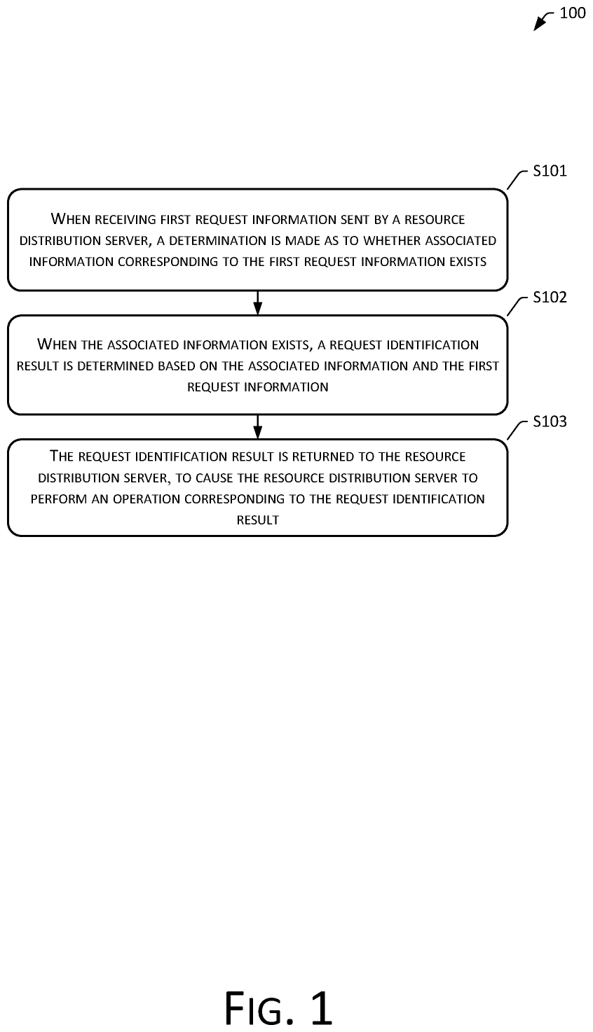

FIG. 1 is a flowchart of a request identification method 100 according to an exemplary embodiment. This method 100 can be applied in a target server. As shown in FIG. 1, a request identification method 100 may include the following operations.

At S101, when receiving first request information sent by a resource distribution server, a determination is made as to whether associated information corresponding to the first request information exists, wherein the first request information is determined by the resource distribution server based on a first resource request of a terminal.

At S102, when the associated information exists, a request identification result is determined based on the associated information and the first request information.

At S103, the request identification result is returned to the resource distribution server, to cause the resource distribution server to perform an operation corresponding to the request identification result.

According to the embodiments of the present disclosure, in response to receiving first request information by a target server, a determination is made as to whether associated information corresponding to the first request information exists. When the associated information exists, a request identification result is determined according to the associated information and the first request information. Therefore, the accuracy of request identification is improved.

The target server may be any server configured to identify a request. The resource distribution server may include a service distribution server that provides a resource (e.g., various types of resources such as a video resource, an audio resource, a game resource, etc) to a requesting end (e.g., a user terminal or the like). Examples are a content distribution network CDN (Content Delivery Network) server, a cloud storage, etc.

The first request information is determined by the resource distribution server based on the first resource request from the terminal, and may include various types of parameters related to the first resource request, e.g., one or more of: effective time information related to the first resource request (e.g., a validity period, an effective time status, time stamp information, etc., of the first resource request), temporal order information related to the first resource request (e.g., a request order of the first resource request and other requests, etc.), user information related to the first resource request (e.g., user account information, user level information, etc.), terminal information related to the first resource request (e.g., a system of the terminal, a model of the terminal, etc.), and related information of the resource corresponding to the first resource request (e.g., information such as an identifier of the resource, a type of the resource, a size, etc.). The present disclosure does not have any limitation on specific content included in the first request information, as long as the content can represent characteristics of the first resource request, and realize identification of whether the request is normal or abnormal. The first resource request may be a request that is related various resources and sent by a user terminal to the resource distribution server, which may be, for example, a video download, a video caching, or the like.

The associated information may be information that corresponds to the first request information and is stored or obtained by the target server. The associated information may be used for determining the request identification result. The associated information corresponding to the first request information may be one or more, and may come from a same server or a different server.

The present disclosure does not have any limitation on a type of the resource distribution server, a form and content of the first request information, a form and content of the first resource request, and the number, source, form, and content of the associated information.

In an exemplary application scenario, a user a wants to play an exclusive drama show A of a certain platform. For example, a terminal thereof acquires an URL (Uniform Resource Locator) of the exclusive drama show A through an unconventional means. The terminal requests a CDN server (a resource distribution server) to obtain a video resource (a first resource request) of the exclusive drama show A according to the URL, and hopes to illegally acquire broadcasting privileges of a legitimate user.

In this application example, when receiving the first resource request from the terminal of the user a, the CDN server determines first request information (for example, extracts a unique play identifier from the URL, and video id information of the exclusive drama show A that is requested, etc., as the first request information). The CDN server transmits the determined first request information to a target server.

In this application example, the target server receives the first request information, and determines whether associated information corresponding to the first request information exists. For example, the target server may determine whether associated information corresponding to the first request information exists according to the unique play identifier in the first request information. For example, the URL obtained by the user through the non-conventional means is the one that is requested and obtained by a legitimate user b in a conventional manner. The target server stores request information related to a request of the user b, and the request information includes a unique play identifier that is the same as the one in the first request information. The target server determines that the request information is the associated information corresponding to the first request information.

In this application example, the target server may determine a request identification result based on the associated information and the first request information. For example, the target server determines that the time for requesting the URL in the associated information is 36 hours ago. Effective time information of the associated information has expired, and user information (e.g., a user id) of the associated information does not match user information in the first request information. A request identification result can be determined as an abnormal request.

In this application example, the target server may return the request identification result to the CDN server. The CDN server may perform an operation corresponding to the request identification result, for example, refusing to return video resources, etc., and providing real-time playback download blocking capabilities.

In this way, the target server can perform request identification in a universal manner without terminals being aware of and without any need for upgrades, which can improve the accuracy of request identification, reduce the probability of resource wastes caused by responding to abnormal requests, reduce the maintenance cost of request identification, and reduce damages of the abnormal requests to a resource provider and legitimate rights and interests of legitimate target users.

In implementations, a resource requested by the first resource request may be any content that can be requested, for example, may be a video resource (a video file, a video stream, etc.), an audio resource, a game resource, etc, which is not limited by the present disclosure. For the sake of understanding, a video resource is used as an example of the resource that is requested, a CDN server is used as an example of the resource distribution server.

For example, in response to receiving the first request information sent by the CDN server, the target server may determine whether associated information corresponding to the first request information exists in a plurality of manners. For example, as described above, the associated information corresponding to the first request information may be determined according to the parameters (for example, a unique play identifier, etc.) that are included in the first request information, which is not limited in the present disclosure. For example, if the first request information and other request information acquired or stored by the target server have same parameter(s) of specified type(s) (for example, a unique play identifier, etc.), the other request information may be considered as the associated information of the first request information.

As shown in FIG. 1, at S102, when the associated information exists, a request identification result is determined based on the associated information and the first request information.

A request identification result may include multiple forms and multiple pieces of content, for example, may be an abnormal request, a normal request, or the like, or may be requests of different levels and different degrees (for example, divided into multiple levels, first-level normal request, second-level normal request, third-level abnormal request, etc.), which are not limited by the present disclosure.

For example, in response to determining that the associated information exists, the target server may combine the first request information and the associated information according to preset determination rule(s) to determine a request identification result. For example, the associated information may be compared with the first request information (e.g., a comparison of parameters, etc.), and the request identification result is determined based on a result of the comparison. For example, when each parameter matches, a determination is made that the request identification result is a normal request.

In implementations, an associated channel corresponding to the first request information may be pre-configured. In response to determining that the associated information exists, the request identification result may be determined based on the associated information, the associated channel, and the first request information.

For example, when the target server predefines the first request information to be come from the resource distribution server (for example, a CDN server), the associated channel corresponding to the first request information includes: an associated channel with an advertisement server and an associated channel with a resource control server. For example, when the associated information that is determined does not include request information of a preset associated channel, the request identification result may be determined to be an abnormal request. For example, in response to determining that one piece of associated information (for example, the request information comes from the resource control server), a determination may be made that the request identification result is an abnormal request, because two associated channels are pre-configured, and request information (associated information) from the advertisement server corresponding to the first request information is missing.

It should be understood that determination rules can be flexibly configured according to various conditions such as a desired level of security prevention and control, content and form of the requested resource, respective content and forms of the first request information and the associated information, etc. For example, for resources that have a higher desired level of security prevention and control (e.g., exclusive drama show, etc.), stricter judgment criteri(a) can be configured. For resources of common desired level of security prevention and control, looser judgment criteri(a) can be configured (for example, when determining whether the first request information and the related information matches, it is considered as a match if some parameters are consistent). The present disclosure does not have any limitations on the manner of determining the request identification result based on the associated information and the first request information.

In implementations, the associated information may include second request information sent by a resource control server. The second request information is determined by the resource control server according to a second resource request from the terminal. The first resource request is a request initiated by the terminal according to resource acquisition information. The resource acquisition information is information returned by the resource control server for the second resource request.

The resource control server may be a server that is provided by a resource provider and is used for outputting information related to resource acquisition (for example, a URL, etc.) to a user in response to a user request. Examples are a video streaming server, an audio streaming server, a live server, and the like. The resource acquisition information may be information returned by the resource control server for the second resource request, which may be any type of information that can be used to obtain a requested resource. The resource acquisition information may include an address used for obtaining a resource requested by the second resource request, and the like. The second resource request may be a request that is related to a resource and is sent by the user terminal to the resource control server, for example, a video play request, etc.

The second request information is determined by the resource control server according to the second resource request received from the terminal, and may include various types of parameters related to the second resource request. Examples thereof may include one of more of: information related to a resource itself (for example, information such as an identifier of the resource, a category of the resource, a size, and the like), effective time information related to the second resource request (e.g., a validity period of the second resource request, an effective time state, timestamp information, etc.), and temporal order information of the second resource request (e.g., a request order of the second resource request and other requests, etc.), user information related to the second resource request (e.g., user account information, user level information, etc.) and terminal information related to the second resource request (for example, a system of the terminal, a model of the terminal, and the like). The present disclosure does not limit specific content included in the second request information, as long as the content can represent characteristics of the second resource request, and realizes identification of a request as normal or abnormal.

The present disclosure does not limit a type of the resource control server, a form and content of the second request information, a form and content of the second resource request, etc.

For example, a user b wishes to play an exclusive drama show A, and can send a second resource request to a video streaming server, for example, requesting to play the exclusive drama show A. The video streaming server may determine second request information according to the second resource request. For example, the video streaming server extracts a video id requested to be played in the second resource request to obtain a corresponding video resource. The video streaming server can generate a unique play identifier to record this request. The video streaming server may determine the video id and the unique play identifier as the second request information. The video streaming server may send the second request information determined thereby to a target server.

The video streaming server (the resource control server) may return resource acquisition information for the second resource request. For example, the resource acquisition information may be generated based on the second request information determined by the second resource request, and the resource acquisition information is returned to a user terminal. The resource acquisition information may include an address (e.g., a URL, etc.) used for acquiring the resource requested by the second resource request. The terminal of the user b may initiate a first resource request to the CDN server according to the resource acquisition information. As described above, the CDN server determines the first request information according to the first resource request from the terminal of the user b, and transmits the first request information to the target server.

When receiving first request information sent by the resource distribution server, the target server determines whether associated information corresponding to the first request information exists. For example, using a unique play identifier, a determination is made that the associated information includes the second request information sent by the video streaming server.

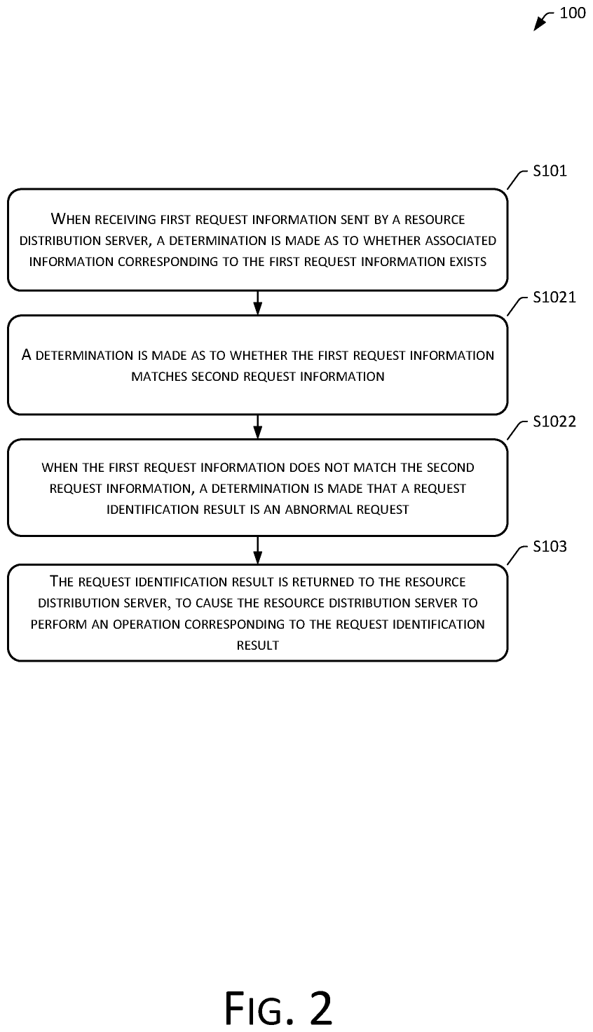

FIG. 2 is a flowchart of a request identification method 100 according to an exemplary embodiment. In implementations, as shown in FIG. 2, S102 may include the following operations.

At S1021, a determination is made as to whether the first request information matches second request information.

At S1022, when the first request information does not match the second request information, a determination is made that a request identification result is an abnormal request.

For example, the CDN server determines that the associated information corresponding to the first request information includes the second request information. The CDN server may determine whether the first request information matches the second request information. For example, the first request information may be compared with the second request information to determine whether a match is made. If the first request information does not match the second request information, a determination may be made that the request identification result is an abnormal request. If the first request information matches the second request information, a determination may be made that the request identification result is a normal request. It should be understood that, when determining whether the first request information matches the second request information, various determination standards, determination rules, and the like may be flexibly configured according to a desired level of security prevention and control, as described above, which is not repeatedly described herein.

In implementations, determining whether the first request information matches the second request information (S1021) may include:

if at least one parameter mismatch exists, determining that the first request information does not match the second request information.

For example, as described above, the second request information includes a plurality of parameters. The target server may determine that the first request information does not match the second request information if at least one parameter mismatch exists. For example, when user information (for example, a user account) does not match, a determination may be made that the first request information does not match the second request information.

In this way, an information exchange between the resource control server and the resource distribution server can be realized through the target server, thus achieving an information closed loop. This can effectively prevent the resource acquisition information returned by the resource control server from being stolen and illegally used, thereby effectively reducing the probability of responding to unconventional requests, and increasing the accuracy of request identification.

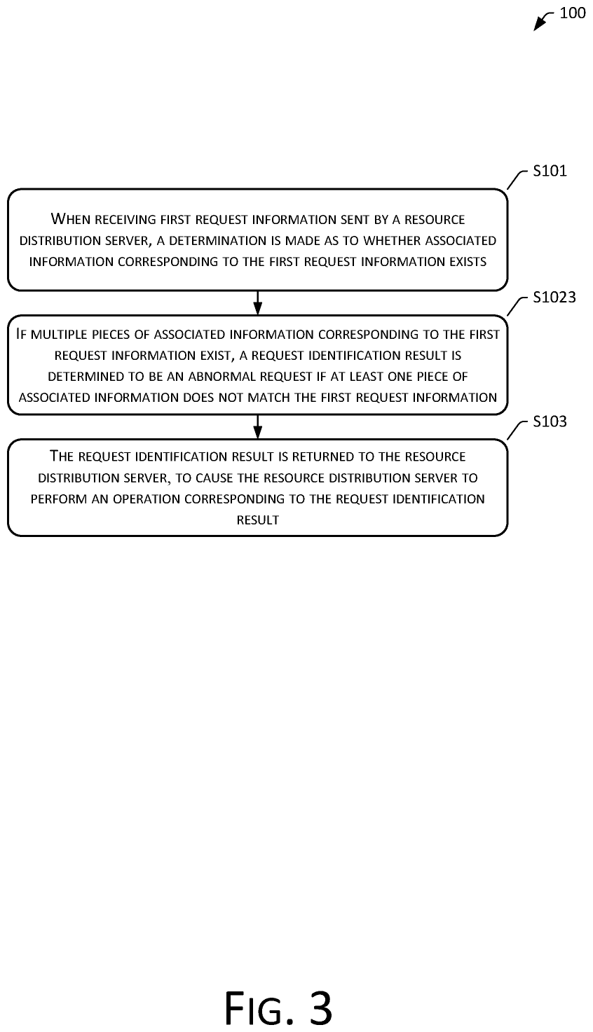

FIG. 3 is a flowchart of a request identification method 100 according to an exemplary embodiment. In implementations, as shown in FIG. 3, S102 may include the following operation.

At S1023, if multiple pieces of associated information corresponding to the first request information exist, a request identification result is determined to be an abnormal request if at least one piece of associated information does not match the first request information.

For example, the associated information determined by the target server corresponding to the first request information may be multiple pieces. For example, in a video service, the associated information corresponding to the first request information may include third request information from an advertisement server or the like, in addition to the second request information described above. For example, the user terminal initiates an advertisement resource request to the advertisement server, and the advertisement server determines the third request information according to the advertisement resource request, and transmits the third request information to the target server.

For example, the target server may determine that the associated information corresponding to the first request information includes the second request information and the third request information, according to the unique play identifier (e.g., the first request information, the second request information, and the third request information all include the unique play identifier). The target server may determine whether the first request information matches the second request information and the third request information, for example, determine whether or not they match based on corresponding judgment criteria.

For example, when the resource distribution server determines the first request information according to the first resource request of the user terminal, when the resource control server determines the second request information according to the second resource request of the user terminal, and when the advertisement server determines the third request information according to the advertisement resource request of the user terminal, information related to a key service (for example, a specific video on demand service, etc.), for example, specific field information, etc., is set in the first request information, the second request information, and the third request information respectively. The target server may determine whether each piece of the associated information matches the first request information according to respective field information in the first request information, the second request information, and the third request information. For example, the first request information, the second request information, and the third request information all include the same field information. In this case, the first request information, the second request information, and the third request information match with each other.

In implementations, for example, the second request information and the first request information include the same field information, and the field information in the third request information is different from the field information of the first request information. A determination is made that the third request information and the first request information do not match. The target server can determine that the request identification result is an abnormal request.

In this way, a determination of request identification can be performed more comprehensively, and the accuracy of request identification can be improved. The present disclosure does not limit content such as the judgment criteria for whether the associated information and the first request information match, form and content of the field information, and the like, as long as they can be used to determine whether the associated information and the first request information match.

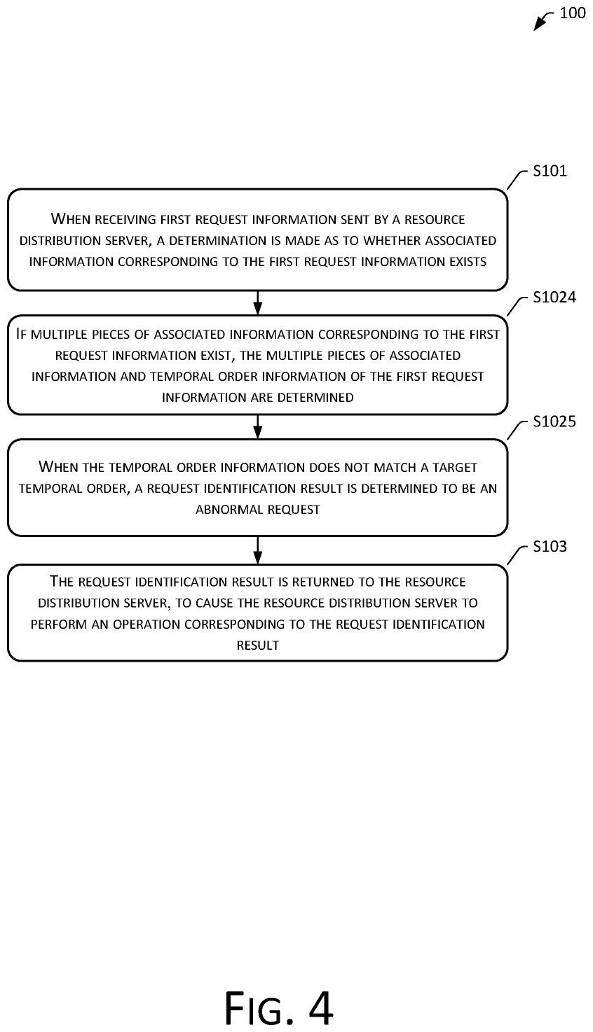

FIG. 4 is a flowchart of a request identification method 100 according to an exemplary embodiment. In implementations, as shown in FIG. 4, S102 may include the following operations.

At S1024, if multiple pieces of associated information corresponding to the first request information exist, the multiple pieces of associated information and temporal order information of the first request information are determined.

At S1025, when the temporal order information does not match a target temporal order, a request identification result is determined to be an abnormal request.

For example, within a target time interval (e.g., within a period of time before and after receiving the first request information), there may be second request information and third request information corresponding to the first request information (the second request information and the third request information is associated information). The target server may determine multiple pieces of associated information and temporal order information of the first request information. For example, according to respective timestamp information in the first request information, the second request information, and the third request information, the temporal order information of the first request information, the second request information, and the third request information may be determined as: the first request information, the third request information, and second request information. (For example, this may indicate that the user terminal sequentially sends requests to the resource distribution server, the advertisement server, and the resource control server).

In some optional embodiments, a conventional resource request procedure is pre-configured. For example, when requesting to acquire a video resource, a user terminal sequentially sends requests to a resource control server, a resource distribution server, and an advertisement server. A target temporal order preset by a corresponding target server is: second request information from the resource control server, first request information from the resource distribution server, and third request information from the advertisement server. For example, the target server determines a temporal order of the first request information, the second request information, and the third request information to be: the first request information, the third request information, and the second request information, which does not match with the target temporal order. The request identification result may be determined to be an abnormal request.

In this way, a determination of request identification can be performed more comprehensively, and the accuracy of request identification can be improved. The present disclosure does not limit specific manners of determination of a target time interval, a length of the time interval, manners of determining multiple pieces of associated information and temporal order information of the first request information, and forms, content, and determination methods of a target temporal order.

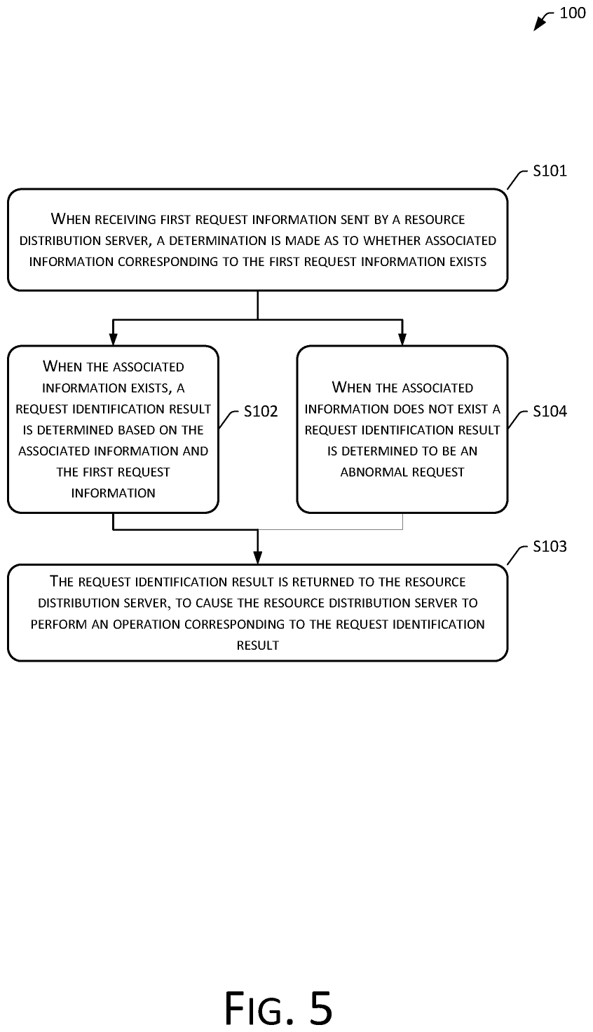

FIG. 5 is a flowchart of a request identification method 100 according to an exemplary embodiment. In implementations, as shown in FIG. 5, the method 100 may further include the following operation.

At S104, when the associated information does not exist the request identification result is determined to be an abnormal request.

For example, when receiving the first request information sent by the CDN server, the target server may search for corresponding associated information according to the unique play identifier in the first request information as described above. When the target server cannot find the associated information, a determination can be made that the request identification result is an abnormal request.

In this way, the request can be identified quickly and accurately.

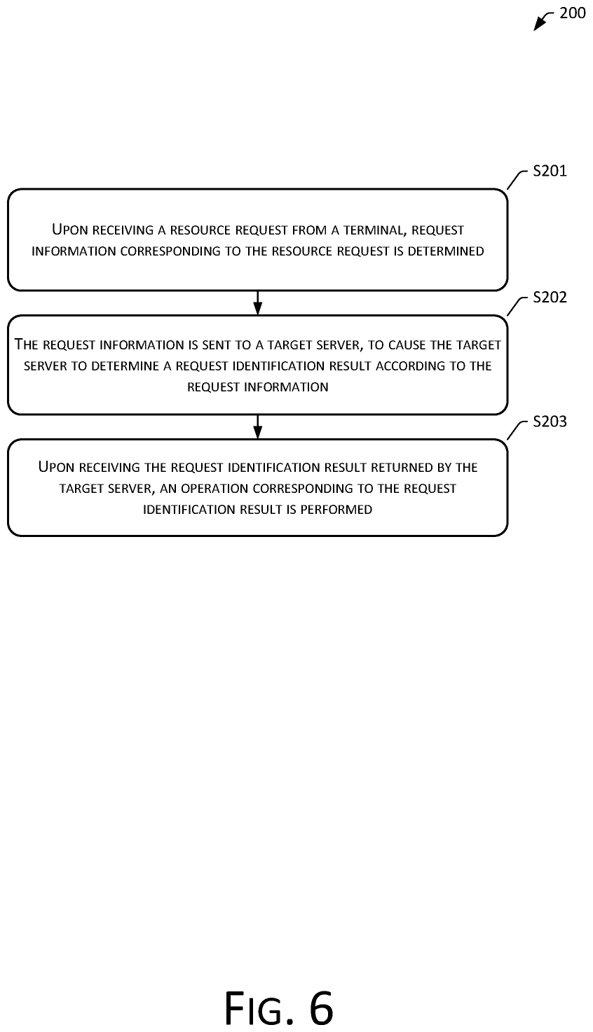

FIG. 6 is a flowchart of a request identification method 200 according to an exemplary embodiment. This method can be applied in a resource distribution server. As shown in FIG. 6, the request identification method 200 may include the following operations.

At S201, upon receiving a resource request from a terminal, request information corresponding to the resource request is determined.

At S202, the request information is sent to a target server, to cause the target server to determine a request identification result according to the request information.

At S203, upon receiving the request identification result returned by the target server, an operation corresponding to the request identification result is performed.

According to the embodiments of the present disclosure, when receiving a resource request from a terminal, a resource distribution server determines request information corresponding to the resource request, transmits the request information to a target server, and performs an operation corresponding to a request identification result upon receiving the request identification result return from the target server, thereby improving the accuracy of identifying the resource request.

The resource request can be any request related to a resource. A form and content of the request information are the same the ones as described above for the first request information and the second request information, and are not repeatedly described herein. Here, a video request is taken as an example of the resource request of the terminal, and a CDN server taken as an example of the resource distribution server for illustration.

For example, when receiving a resource request from a terminal, the CDN server determines request information corresponding to the resource request. For example, a URL included in the resource request is extracted and analyzed, and request information, including various types of information such as a unique play identifier and a video id, etc., is determined. The CDN server transmits the determined request information to a target server. As described above, the target server returns a request identification result. In response to receiving the request identification result returned by the target server, the CDN server performs an operation corresponding to the request identification result. The request identification result may include multiple forms and multiple pieces of content as described above, and details thereof are not repeatedly described herein. The operation corresponding to the request identification result may include multiple forms, for example, returning a resource corresponding to the resource request to the terminal, rejecting a provision of the resource corresponding to the resource request to the terminal, etc., which is not limited in the present disclosure.

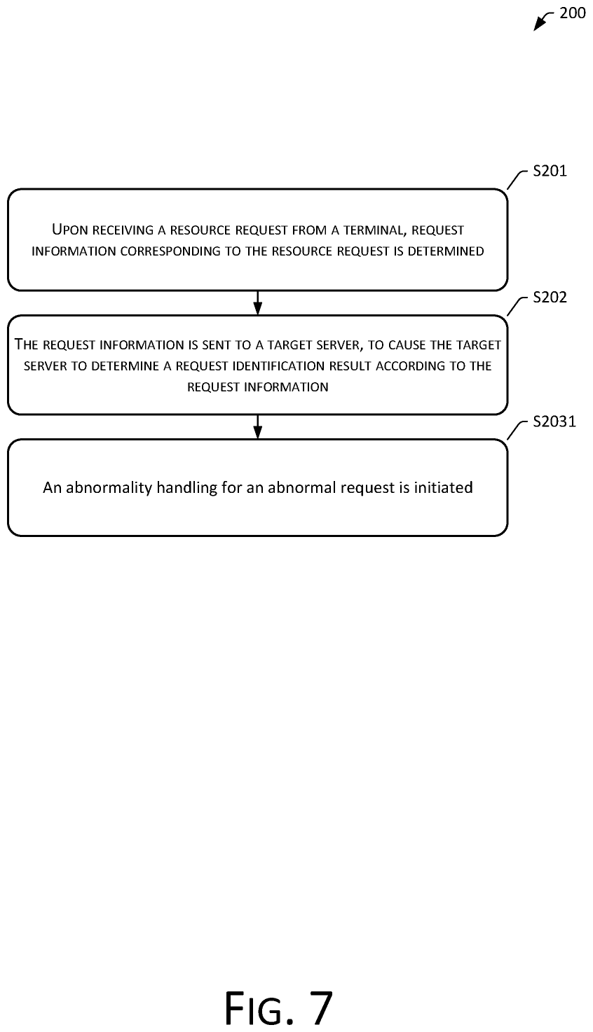

FIG. 7 is a flowchart of a request identification method 200 according to an exemplary embodiment. In implementations, the request identification result includes an abnormal request. As shown in FIG. 7, S203 may include the following operation.

At S2031, an abnormality handling for an abnormal request is initiated.

For example, as described above, the request identification result may include an abnormal request. The resource distribution server can initiate an abnormality handling for the abnormal request. For example, refusing to return a corresponding resource, controlling the terminal to display a return failure and the like, etc., which is not limited by the present disclosure.

In this way, abnormality handling of resource requests can be performed quickly and accurately, thus reducing the probability of a waste of resources.

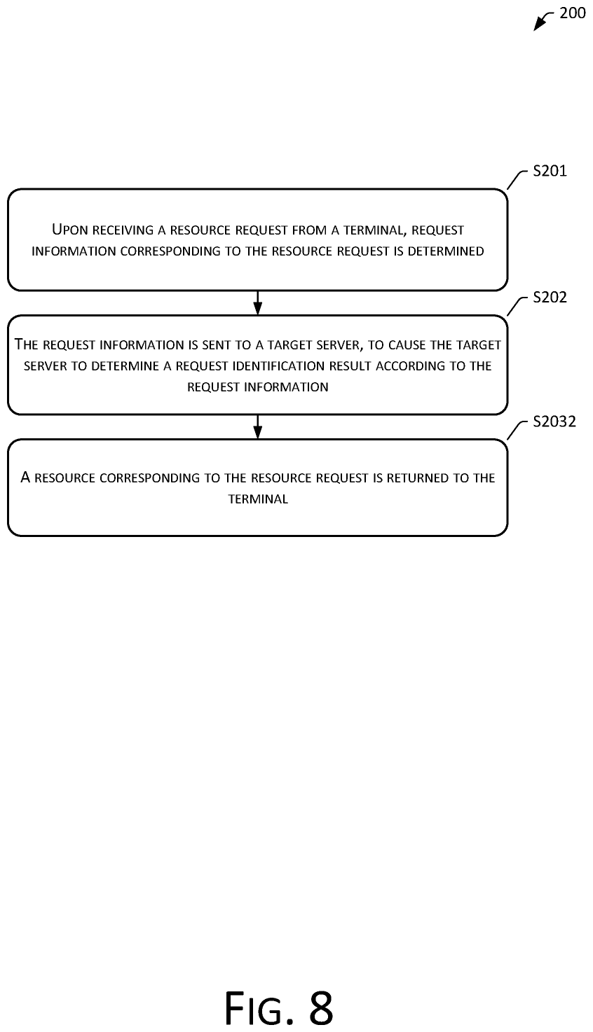

FIG. 8 is a flowchart of a request identification method 200 according to an exemplary embodiment. In implementations, the request identification result includes a normal request. As shown in FIG. 8, S203 may include the following operation.

At S2032, a resource corresponding to the resource request is returned to the terminal.

For example, as described above, the request identification result may include a normal request. The resource distribution server may return a resource corresponding to the resource request to the terminal. For example, a video stream and a video file requested by the terminal are returned to the terminal, so that the terminal performs a video playback.

In this way, resource requests can be processed quickly and accurately.

### Application Example

An application example according to an embodiment of the present disclosure is given hereinafter in conjunction with using “playing a video by a user” as an exemplary application scenario to facilitate the understanding of a process of a request identification method. One skilled in the art should understand that the following application example is only used for the purpose of understanding the embodiments of the present disclosure, and should not be construed as limiting the embodiments of the present disclosure.

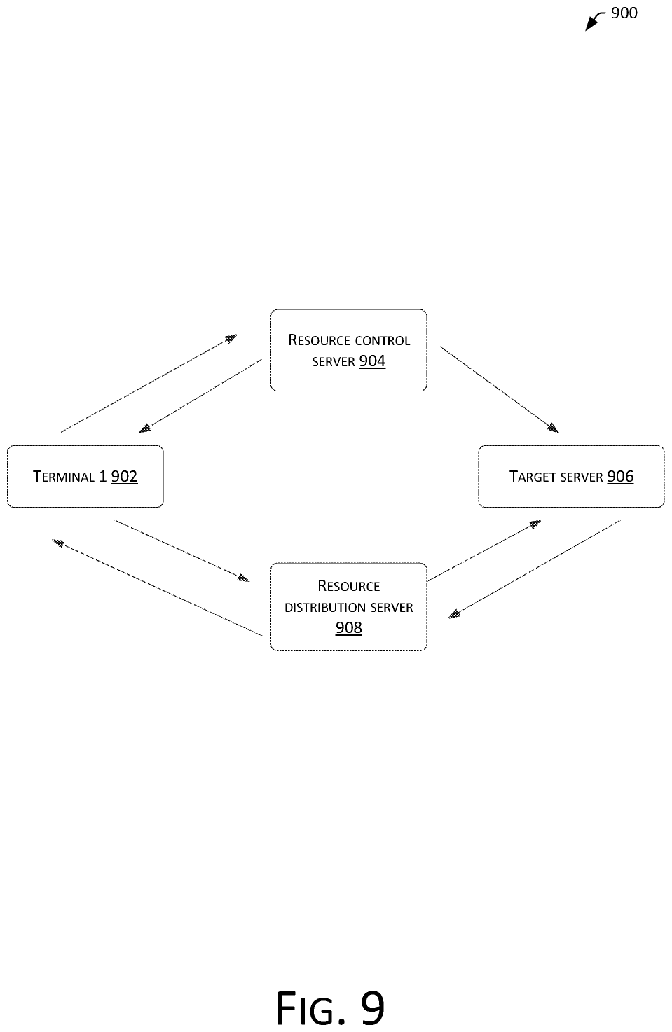

FIG. 9 is a schematic diagram of an application scenario 900 of a request identification method according to an exemplary embodiment. In this application example, as shown in FIG. 9, a user b wishes to play an exclusive drama show A of a certain platform, and a terminal 902 (a terminal 1) transmits a video play request for playing the exclusive drama show A to a video streaming server (i.e., a resource control server) 904. Upon receiving the video play request, the video streaming server 904 extracts a video id (a video id of the exclusive drama show A) from the video play request, and generates a unique play identifier to record current video play information. In this application example, the video streaming server 904 transmits request information such as the video id, the unique play identifier, and the like to a target server 906. The target server 906 may store the request information such as the video id, the unique identifier, and the like (e.g., as second request information).

In this application example, the video streaming server 904 may generate a media distribution string according to the request information such as the video id, the unique play identifier, and the like, for example, a PURL (Persistent Uniform Resource Locator). The video streaming server 904 can return the PURL to the terminal 902 of the user b.

In this application example, the terminal 902 of the user b initiates a video request to a CDN server (i.e., a resource distribution server) 908 according to the PURL. In response to receiving the video request, the CDN server 908 may extract first request information, such as the video id, the unique play identifier, and the like, from the PURL included in the video request. The CDN server 908 can send the first request information to the target server 906.

In this application example, when receiving the first request information, the target server 906 may determine whether associated information corresponding to the first request information exists. For example, according to the unique play identifier included in the first request information, the target server 906 may determine that second request information that is received and stored by the video streaming server 904 is the associated information corresponding to the first request information. The target server 906 may determine a request identification result according to the first request information and the second request information (the associated information). For example, the first request information and the second request information match, and the request recognition result is a normal request. The target server 906 returns the request identification result as a normal request to the CDN server 908.

In this application example, upon receiving the request identification result, the CDN server 908 performs an operation corresponding to the request identification result, for example, returns a video stream of the exclusive drama show A requested by the user b to the user b.

In this application example, the user a wants to play the exclusive drama how A of a certain platform, for example, a terminal thereof obtains the PURL of the exclusive drama show A through an unconventional means, and the terminal thereof requests the CDN server 908 to acquire a video resource of the exclusive drama show based on the PURL.

In this application example, the CDN server 908 receives a first resource request from the terminal of the user a, and determines first request information, for example, extracts a unique play identifier, video id information of the requested exclusive drama show A, and the like, from the URL as the first request information. The CDN server 908 transmits the determined first request information to the target server.

In this application example, the target server 906 receives the first request information, and determines whether associated information corresponding to the first request information exists. For example, the target server 906 may determine whether associated information corresponding to the first request information exists according to the unique play identifier in the first request information. For example, the target server 906 may determine that a request identification result is an abnormal request upon determining that no associated information exists. The target server 906 returns the request identification result as an abnormal request to the CDN server 908.

In this application example, upon receiving the request identification result, the CDN server 908 performs an operation corresponding to the request identification result, for example, rejecting to provide a video stream to the terminal of the user a, and displaying a prompt message indicating a return failure.

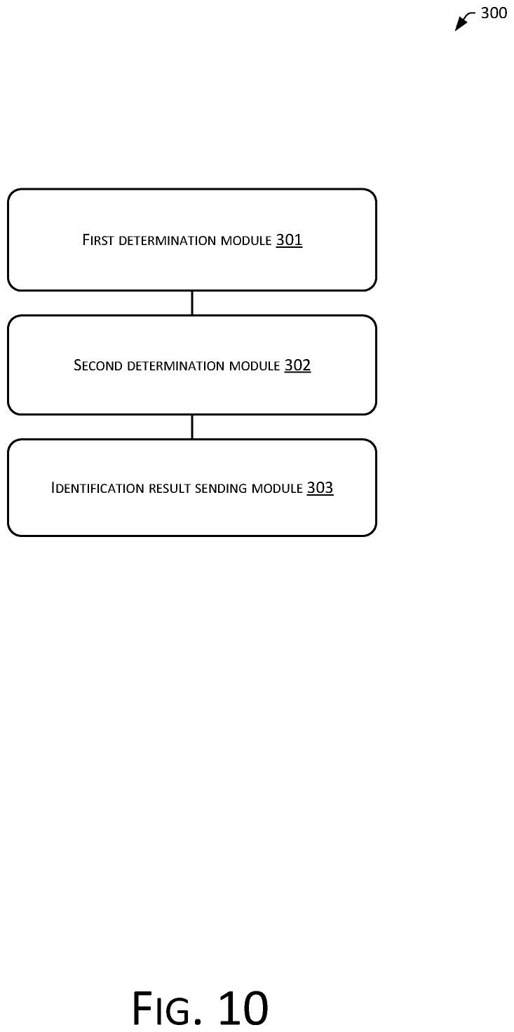

FIG. 10 is a block diagram of a request identification apparatus 300 according to an exemplary embodiment, which is applied in a target server as shown in FIG. 10. The apparatus 300 includes:
a first determination module 301 configured to determine whether associated information corresponding to first request information sent by a resource distribution server exists when receiving the first request information, wherein the first request information is determined by the resource distribution server based on a first resource request from a terminal;
a second determination module 302 configured to determine a request identification result based on the associated information and the first request information when the associated information exists; and
an identification result sending module 303 configured to return the request identification result to the resource distribution server to cause the resource distribution server to perform an operation corresponding to the request identification result.

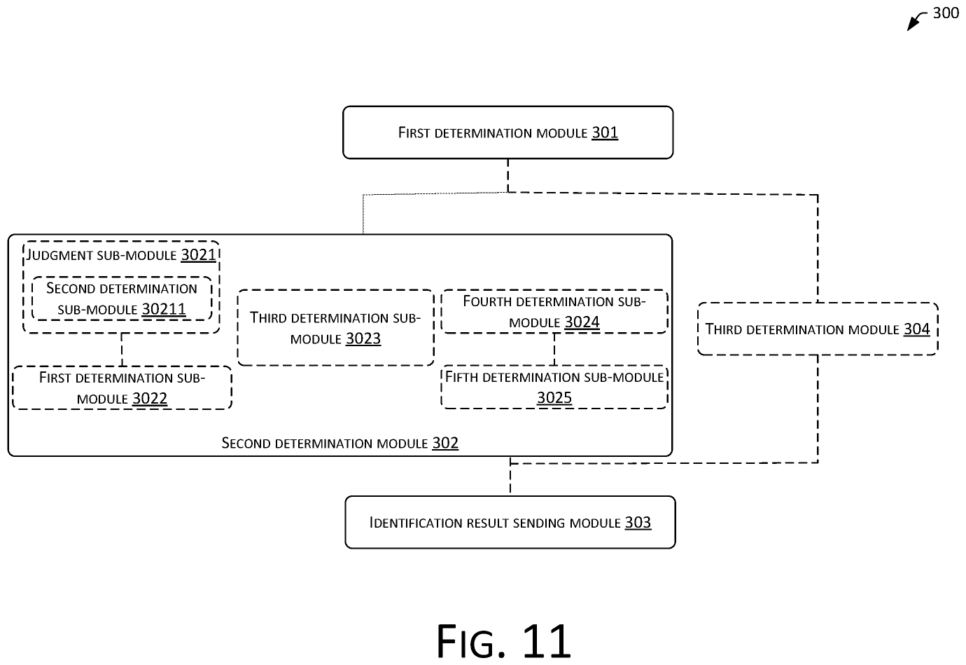

FIG. 11 is a block diagram of a request identification apparatus 300 according to an exemplary embodiment. As shown in FIG. 11, in implementations, the apparatus 300 further includes:
a third determination module 304 configured to determine that the request identification result is an abnormal request when the associated information does not exist.

As shown in FIG. 11, in implementations, the associated information includes second request information sent by a resource control server, wherein the second request information is determined by the resource control server according to a second resource request from the terminal. The first resource request is a request initiated by the terminal according to the resource acquisition information, wherein the resource acquisition information is information returned by the resource control server for the second resource request, wherein the second determination module 302 includes:
a judgment sub-module 3021 configured to determine whether the first request information matches the second request information; and
a first determination sub-module 3022 configured to determine that the request identification result is an abnormal request when the first request information does not match the second request information.

As shown in FIG. 11, in implementations, the second request information includes multiple parameters, wherein the judgment sub-module 3021 includes:
a second determination sub-module 30211 configured to determine that the first request information does not match the second request information when at least one parameter mismatch exists.

As shown in FIG. 11, in implementations, the second determination module 302 includes:
a third determination sub-module 3023 configured to determine that the request identification result is an abnormal request if at least one piece of associated information does not match the first request information, when a plurality of pieces of associated information corresponding to the first request information exist.

As shown in FIG. 11, in implementations, the second determination module 302 includes:
a fourth determination sub-module 3024 configured to determine temporal order information of a plurality of pieces of associated information and the first request information when the plurality of pieces of associated information corresponding to the first request information exist; and
a fifth determination sub-module 3025 configured to determine that the request identification result is an abnormal request when the temporal order information does not match a target temporal order.

In implementations, the parameters include at least one of: information related to a resource, effective time information related to the second resource request, temporal order information related to the second resource request, user information related to the second resource request, and terminal information related to the second resource request.

In implementations, the resource acquisition information includes an address used for obtaining a resource requested by the second resource request.

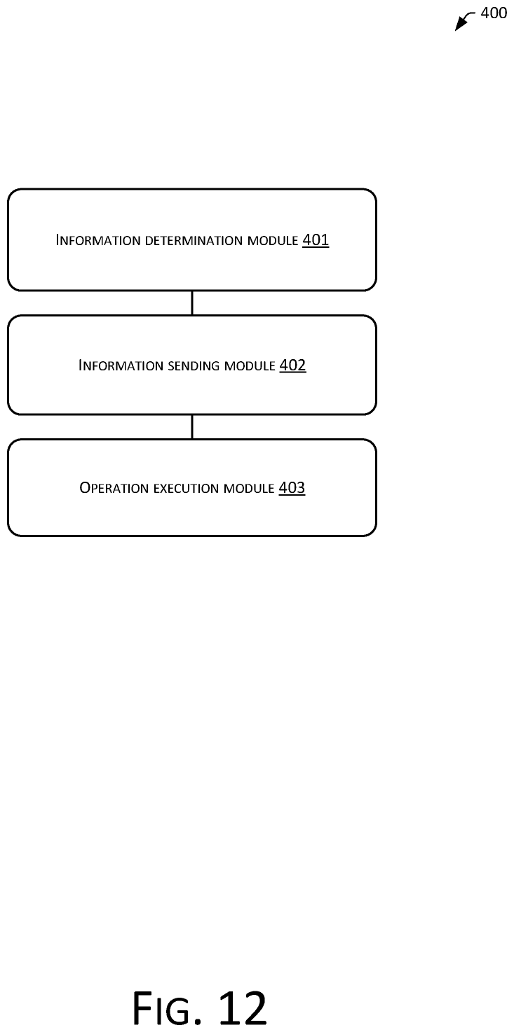

FIG. 12 is a block diagram of a request identification apparatus 400 according to an exemplary embodiment, which is applied in a resource distribution server as shown in FIG. 12. The apparatus 400 includes:
an information determination module 401 configured to determine request information corresponding to a resource request when receiving the resource request from a terminal;
an information sending module 402 configured to send the request information to a target server, to cause the target server to determine a request identification result according to the request information; and
an operation execution module 403 configured to perform an operation corresponding to the request identification result when receiving the request identification result returned by the target server.

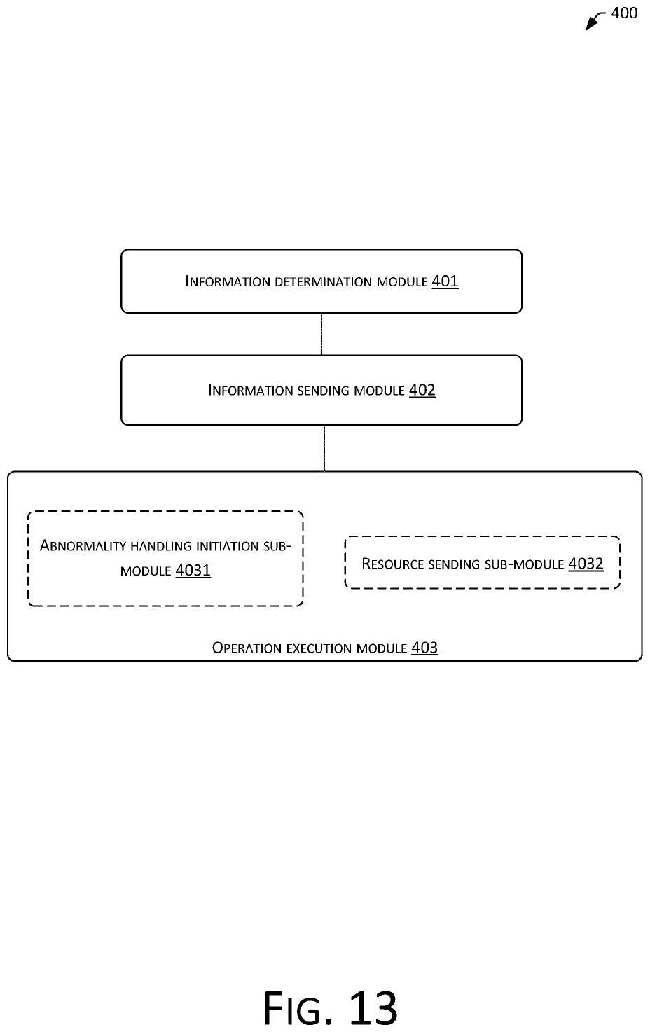

FIG. 13 is a block diagram of a request identification apparatus 400 according to an exemplary embodiment. As shown in FIG. 13, in implementations, the request identification result includes an abnormal request, wherein the operation execution module 403 includes:
an abnormality handling initiation sub-module 4031 configured to initiate an abnormality handling for the abnormal request.

As shown in FIG. 13, in implementations, the request identification result includes a normal request, wherein the operation execution module 403 includes:
a resource sending sub-module 4032 configured to return a resource corresponding to the resource request to the terminal.

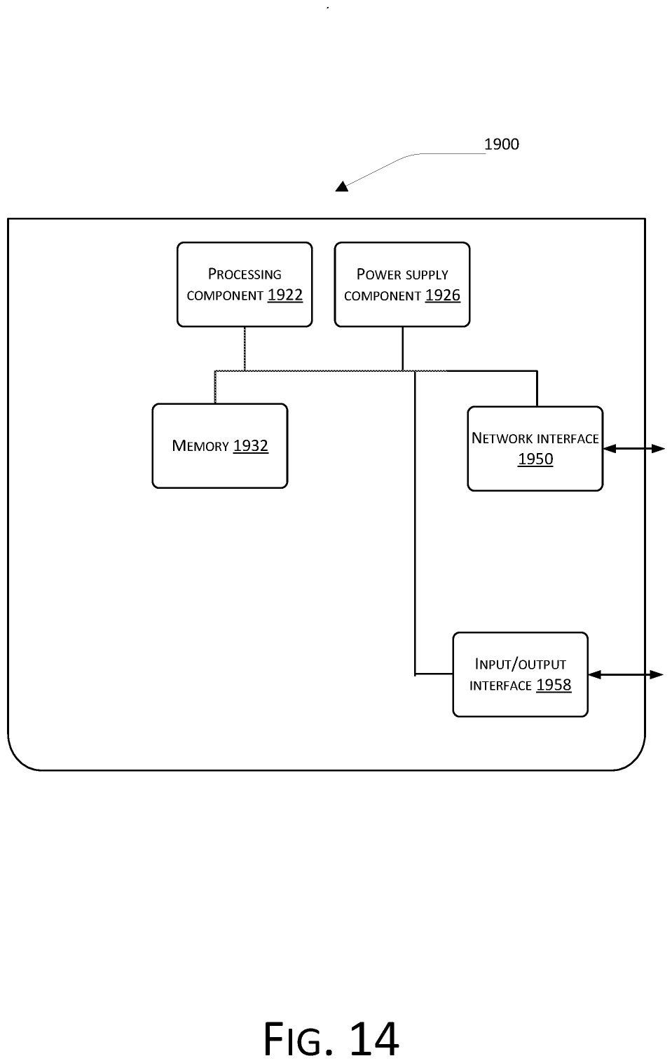

FIG. 14 is a block diagram of an example request identification apparatus such as the request identification apparatus 300 in FIG. 10 or FIG. 11, or the request identification apparatus 400 in FIG. 12 or FIG. 13 in further detail. In implementations, the apparatus 1900 can alternatively be provided as a server such as a target server or a resource distribution server. Referring to FIG. 14, the apparatus 1900 includes a processing component 1922, which further includes one or more processors, and memory resources represented by a memory 1932, which is configured to store instructions executable by the processing component 1922, such as an application program. An application program stored in the memory 1932 can include one or more modules, each corresponding to a set of instructions.

Additionally, the processing component 1922 is configured to execute instructions to perform the methods described above.

The apparatus 1900 can also include a power supply component 1926 configured to perform power management of the apparatus 1900, a wired or wireless network interface 1950 configured to connect the apparatus 1900 to a network, and an input/output (I/O) interface 1958. The apparatus 1900 can operate perform operations based on an operating system stored in the memory 1932, such as Windows Server™, Mac OS X™, Unix™, Linux™, FreeBSD™, or the like.

In an exemplary embodiment, a non-transitory computer readable storage medium is also provided, such as the memory 1932 including computer program instructions. The computer program instructions are executable by the processing component 1922 of the apparatus 1900 to perform the above methods.

The present disclosure can be a system, method, and/or a computer program product. The computer program product can include a computer readable storage medium having computer readable program instructions embodied thereon to cause processor(s) to implement various aspects of the present disclosure.

The computer readable storage medium can be a tangible device that can maintain and store instructions used by an instruction execution device. The computer readable storage medium can be, for example, but is not limited to, an electrical storage device, a magnetic storage device, an optical storage device, an electromagnetic storage device, a semiconductor storage device, or any suitable combination of the foregoing. More specific examples (a non-exhaustive list) of computer readable storage media include: a portable computer disk, a hard disk, a random access memory (RAM), a read only memory (ROM), an erasable programmable read only memory (EPROM) or flash memory), a static random access memory (SRAM), a portable compact disk read only memory (CD-ROM), a digital versatile disk (DVD), a memory stick, a floppy disk, a mechanical encoding device, for example, a hole card or raised structures in grooves having instructions stored thereon, and any suitable combination of the foregoing. A computer readable storage medium that is used herein is not to be interpreted as a transient signal itself, such as a radio wave or other freely propagating electromagnetic wave, an electromagnetic wave propagating through a waveguide or other transmission medium (e.g., a light pulse through a fiber optic cable), or an electrical signal transmitted through a wire.

Computer readable program instructions described herein can be downloaded from a computer readable storage medium to various computing/processing devices or downloaded to external computers or external storage devices through a network, such as the Internet, a local area network, a wide area network, and/or a wireless network. The network may include copper transmission cables, fiber optic transmissions, wireless transmissions, routers, firewalls, switches, gateway computers, and/or edge servers. A network adapter card or network interface in each computing/processing device receives computer readable program instructions through a network and forwards the computer readable program instructions to allow storage in a computer readable storage medium in each computing/processing device.

Computer program instructions used for performing operations of the present disclosure may be assembly instructions, instruction set architecture (ISA) instructions, machine instructions, machine-related instructions, microcode, firmware instructions, state configuration data, or source codes or object codes written in any combination of one or more programming languages. The programming languages include object-oriented programming languages such as Smalltalk, C++, etc., as well as conventional procedural programming languages such as the “C” language or similar programming languages. The computer readable program instructions can be executed entirely on a user's computer, executed partly on a user's computer, executed as a stand-alone software package, executed partly on a user's computer and partly on a remote computer, or entirely on a remote computer or server. When a remote computer is involved, the remote computer can be connected to a user's computer through any type of network, including a local area network (LAN) or a wide area network (WAN), or can be connected to an external computer (e.g., connected through the Internet using an Internet service provider). In some embodiments, state information of computer readable program instructions can be used to customize an electronic circuit, such as a programmable logic circuit, a field programmable gate array (FPGA), or a programmable logic array (PLA). Such electronic circuit can execute the computer readable program instructions to implement various aspects of the present disclosure.

Depending on which request identification apparatus (such as the request identification apparatus 300 or the request identification apparatus 400) the apparatus 1900 represents, the memory 1932 may include one or more modules and/or sub-modules as described in the foregoing description and FIGS. 10-13.

Aspects of the present disclosure are described herein with reference to flowcharts and/or block diagrams of methods, apparatus, and computer program products according to the embodiments of the present disclosure. It should be understood that each block of the flowcharts and/or block diagrams, and each combination of blocks in the flowcharts and/or block diagrams can be implemented by computer readable program instructions.

These computer readable program instructions can be provided to a general purpose computer, a special purpose computer, or a processor of other programmable data processing apparatus to produce a machine, such that these instructions implement functions/acts specified in one or more of the blocks of the flowcharts and/or block diagrams when being executed by a processor of a computer or other programmable data processing apparatus. The computer readable program instructions can also be stored in a computer readable storage medium. The computer readable program instructions cause a computer, programmable data processing device, and/or other device to operate in a particular manner, such that the computer readable medium storing the instructions includes an article of manufacture, and includes instructions for implementing various aspects of the functions/acts specified in one or more of the blocks of the flowcharts and/or block diagrams.

The computer readable program instructions can also be loaded onto a computer, other programmable data processing device, or other device to perform a series of operational steps on the computer, the other programmable data processing device or the other device to produce a computer-implemented process. As such, the instructions executed on the computer, the other programmable data processing apparatus, or the other device implement the functions/acts specified in one or more of the blocks in the flowcharts and/or block diagrams.

The flowchart and block diagrams in the accompanying drawings illustrate the architecture, functionalities and operations of possible implementations of systems, methods and computer program products according to various embodiments of the present disclosure. In this regard, each block in a flowchart or block diagram can represent a module, a program segment, or a portion of an instruction. The module, the program segment, or the portion of the instruction includes one or more executable instructions used for implementing specified logical function(s). In some alternative implementations, functions noted in the blocks may also occur in an order different from those illustrated in the drawings. For example, two consecutive blocks may be executed substantially in parallel, and may sometimes be executed in a reverse order, depending upon functions that are involved. It is also noted that each block of the block diagrams and/or flowcharts, and combinations of blocks in the block diagrams and/or flowcharts can be implemented in a dedicated hardware-based system that performs specified functions or actions, or can be implemented by a combination of dedicated hardware and computer instructions.

The embodiments of the present disclosure have been described above. The foregoing description is illustrative, not limiting, and not limited to the disclosed embodiments. A number of modifications and changes are apparent to one skilled in the art without departing from the scope and spirit of various embodiments of the present specification. The choice of terms used herein is intended to best explain the principles of the embodiments, practical applications, or technical improvements to the technical fields, or enable other ordinary skill in the art to understand the embodiments disclosed herein.

The present disclosure can be further understood using the following clause.

Clause 1: A request identification method, which is applied in a target server, the method comprising: determining whether associated information corresponding to first request information sent by a resource distribution server exists when receiving the first request information, wherein the first request information is determined by the resource distribution server based on a first resource request from a terminal; determining a request identification result based on the associated information and the first request information when the associated information exists; and returning the request identification result to the resource distribution server to cause the resource distribution server to perform an operation corresponding to the request identification result.

Clause 2: The method of Clause 1, wherein the method further comprises: determining that the request identification result is an abnormal request when the associated information does not exist.

Clause 3: The method of Clause 1, wherein the associated information includes second request information sent by a resource control server, wherein the second request information is determined by the resource control server according to a second resource request from the terminal, the first resource request is a request initiated by the terminal according to resource acquisition information, and the resource acquisition information is information returned by the resource control server for the second resource request, and wherein determining the request identification result based on the associated information and the first request information comprises: determining whether the first request information matches the second request information; and determining that the request identification result is an abnormal request when the first request information does not match the second request information.

Clause 4: The method of claim 3, wherein the second request information comprises multiple parameters, wherein determining whether the first request information matches the second request information comprises: determining that the first request information does not match the second request information when at least one parameter mismatch exists.

Clause 5: The method of Clause 1, wherein determining the request identification result based on the associated information and the first request information comprises: determining that the request identification result is an abnormal request if at least one piece of associated information does not match the first request information, when a plurality of pieces of associated information corresponding to the first request information exist.

Clause 6: The method of Clause 1, wherein determining the request identification result based on the associated information and the first request information comprises: determining temporal order information of a plurality of pieces of associated information and the first request information when the plurality of pieces of associated information corresponding to the first request information exist; and determining that the request identification result is an abnormal request when the temporal order information does not match a target temporal order.

Clause 7: The method of Clause 4, wherein the parameters comprise at least one of information related to a resource, effective time information related to the second resource request, temporal order information related to the second resource request, user information related to the second resource request, and terminal information related to the second resource request.

Clause 8: The method of Clause 3, wherein the resource acquisition information comprises an address used to obtain a resource requested by the second resource request.

Clause 9: A request identification method, which is applied to a resource distribution server, the method comprising: determining request information corresponding to a resource request when receiving the resource request from a terminal; sending the request information to a target server, to cause the target server to determine a request identification result according to the request information; and performing an operation corresponding to the request identification result in response to receiving the request identification result returned by the target server.

Clause 10: The method of Clause 9, wherein the request identification result comprises an abnormal request, wherein performing the operation corresponding to the request identification result comprises: starting an abnormality handling for the abnormal request.

Clause 11: The method of Clause 9, wherein the request identification result comprises a normal request, wherein performing the operation corresponding to the request identification result comprises: returning a resource corresponding to the resource request to the terminal.

Clause 12: A request identification apparatus, which is applied in a target server, the apparatus comprising: a first determination module configured to determine whether associated information corresponding to first request information sent by a resource distribution server exists when receiving the first request information, wherein the first request information is determined by the resource distribution server based on a first resource request from a terminal; a second determination module configured to determine a request identification result based on the associated information and the first request information when the associated information exists; and an identification result sending module configured to return the request identification result to the resource distribution server to cause the resource distribution server to perform an operation corresponding to the request identification result.

Clause 13: The apparatus of Clause 12, wherein the apparatus further comprises: a third determination module configured to determine that the request identification result is an abnormal request when the associated information does not exist.

Clause 14: The apparatus of Clause 12, wherein the associated information comprises second request information sent by a resource control server, wherein the second request information is determined by the resource control server according to a second resource request from the terminal, the first resource request is a request initiated by the terminal according to the resource acquisition information, wherein the resource acquisition information is information returned by the resource control server for the second resource request, and wherein the second determination module comprises: a judgment sub-module configured to determine whether the first request information matches the second request information; and a first determination sub-module configured to determine that the request identification result is an abnormal request when the first request information does not match the second request information.

Clause 15: The apparatus of Clause 14, wherein the second request information comprises multiple parameters, wherein the judgment sub-module includes: a second determination sub-module configured to determine that the first request information does not match the second request information when at least one parameter mismatch exists.

Clause 16: The apparatus of Clause 12, wherein the second determination module comprises: a third determination sub-module configured to determine that the request identification result is an abnormal request if at least one piece of associated information does not match the first request information, when a plurality of pieces of associated information corresponding to the first request information exist.

Clause 17: The apparatus of Clause 12, wherein the second determination module comprises: a fourth determination sub-module configured to determine temporal order information of a plurality of pieces of associated information and the first request information when the plurality of pieces of associated information corresponding to the first request information exist; and a fifth determination sub-module configured to determine that the request identification result is an abnormal request when the temporal order information does not match a target temporal order.

Clause 18: The apparatus of Clause 15, wherein the parameters comprises at least one of: information related to a resource, effective time information related to the second resource request, temporal order information related to the second resource request, user information related to the second resource request, and terminal information related to the second resource request.

Clause 19: The apparatus of Clause 14, wherein the resource acquisition information comprises an address used for obtaining a resource requested by the second resource request.

Clause 20: A request identification apparatus, which is applied to a resource distribution server, the apparatus comprising: an information determination module configured to determine request information corresponding to a resource request when receiving the resource request from a terminal; an information sending module configured to send the request information to a target server, to cause the target server to determine a request identification result according to the request information; and an operation execution module configured to perform an operation corresponding to the request identification result when receiving the request identification result returned by the target server.

Clause 21: The apparatus of Clause 20, wherein the request identification result comprises an abnormal request, and wherein the operation execution module comprises: an abnormality handling initiation sub-module configured to initiate an abnormality handling for the abnormal request.

Clause 22: The apparatus of Clause 20, wherein the request identification result comprises a normal request, and wherein the operation execution module comprises: a resource sending sub-module configured to return a resource corresponding to the resource request to the terminal.

Clause 23: A request identification apparatus comprising: a processor; and a memory storing processor-executable instructions, wherein the processor is configured to perform the method of any one of Clauses 1-8.

Clause 24: A non-transitory computer readable storage medium having computer program instructions stored thereon, wherein the computer program instructions are executed by a processor to implement the method of any one of Clauses 1-8.

Clause 25: A request identification apparatus comprising: a processor; and a memory storing processor-executable instructions, wherein the processor is configured to perform the method of any one of Clauses 9-11.

Clause 26: A non-transitory computer readable storage medium having computer program instructions stored thereon, wherein the computer program instructions are executed by a processor to implement the method of any one of Clauses 9-11.

What is claimed is:

1. A method implemented by a target server, the method comprising:
determining whether associated information corresponding to first request information sent by a resource distribution server exists when receiving the first request information, wherein the first request information is determined by the resource distribution server based on a first resource request from a terminal;
determining a request identification result based on the associated information and the first request information when the associated information exists; and
returning the request identification result to the resource distribution server to cause the resource distribution server to perform an operation corresponding to the request identification result.

2. The method of claim 1, wherein the method further comprises:
determining that the request identification result is an abnormal request when the associated information does not exist.

3. The method of claim 1, wherein the associated information includes second request information sent by a resource control server, wherein the second request information is determined by the resource control server according to a second resource request from the terminal, the first resource request is a request initiated by the terminal according to resource acquisition information, and the resource acquisition information is information returned by the resource control server for the second resource request, and wherein determining the request identification result based on the associated information and the first request information comprises:
determining whether the first request information matches the second request information;
determining that the request identification result is an abnormal request when the first request information does not match the second request information.

4. The method of claim 3, wherein the second request information comprises multiple parameters, wherein determining whether the first request information matches the second request information comprises:
determining that the first request information does not match the second request information when at least one parameter mismatch exists.

5. The method of claim 1, wherein determining the request identification result based on the associated information and the first request information comprises:
determining that the request identification result is an abnormal request if at least one piece of associated information does not match the first request information, when a plurality of pieces of associated information corresponding to the first request information exist.

6. The method of claim 1, wherein determining the request identification result based on the associated information and the first request information comprises:
determining temporal order information of a plurality of pieces of associated information and the first request information when the plurality of pieces of associated information corresponding to the first request information exist; and
determining that the request identification result is an abnormal request when the temporal order information does not match a target temporal order.

7. The method of claim 4, wherein the parameters comprise at least one of information related to a resource, effective time information related to the second resource request, temporal order information related to the second resource request, user information related to the second resource request, and terminal information related to the second resource request.

8. The method of claim 3, wherein the resource acquisition information comprises an address used to obtain a resource requested by the second resource request.

9. One or more computer readable storage media storing executable instructions that, when executed by one or more processors of a resource distribution server, cause the one or more processors to perform acts comprising:
determining request information corresponding to a resource request when receiving the resource request from a terminal;
sending the request information to a target server, to cause the target server to determine a request identification result according to the request information; and
performing an operation corresponding to the request identification result in response to receiving the request identification result returned by the target server.

10. The one or more computer readable storage media of claim 9, wherein the request identification result comprises an abnormal request, wherein performing the operation corresponding to the request identification result comprises:
starting an abnormality handling for the abnormal request.

11. The one or more computer readable storage media of claim 9, wherein the request identification result comprises a normal request, wherein performing the operation corresponding to the request identification result comprises:
returning a resource corresponding to the resource request to the terminal.

12. An apparatus comprising:
one or more processors;
memory;
a first determination module stored in the memory and executable by the one or more processors to determine whether associated information corresponding to first request information sent by a resource distribution server exists when receiving the first request information, wherein the first request information is determined by the resource distribution server based on a first resource request from a terminal;
a second determination module in the memory and executable by the one or more processors to determine a request identification result based on the associated information and the first request information when the associated information exists; and
an identification result sending module in the memory and executable by the one or more processors to return the request identification result to the resource distribution server to cause the resource distribution server to perform an operation corresponding to the request identification result.

13. The apparatus of claim 12, wherein the apparatus further comprises:
a third determination module in the memory and executable by the one or more processors to determine that the request identification result is an abnormal request when the associated information does not exist.

14. The apparatus of claim 12, wherein the associated information comprises second request information sent by a resource control server, wherein the second request information is determined by the resource control server according to a second resource request from the terminal, the first resource request is a request initiated by the terminal according to the resource acquisition information, wherein the resource acquisition information is information returned by the resource control server for the second resource request.

15. The apparatus of claim 14, wherein the second determination module comprises:
a judgment sub-module configured to determine whether the first request information matches the second request information; and
a first determination sub-module configured to determine that the request identification result is an abnormal request when the first request information does not match the second request information.

16. The apparatus of claim 15, wherein the second request information comprises multiple parameters, wherein the judgment sub-module includes:
a second determination sub-module configured to determine that the first request information does not match the second request information when at least one parameter mismatch exists.

17. The apparatus of claim 16, wherein the parameters comprises at least one of:
information related to a resource, effective time information related to the second resource request, temporal order information related to the second resource request, user information related to the second resource request, and terminal information related to the second resource request.

18. The apparatus of claim 14, wherein the resource acquisition information comprises an address used for obtaining a resource requested by the second resource request.

19. The apparatus of claim 12, wherein the second determination module comprises:
a third determination sub-module configured to determine that the request identification result is an abnormal request if at least one piece of associated information does not match the first request information, when a plurality of pieces of associated information corresponding to the first request information exist.

20. The apparatus of claim 12, wherein the second determination module comprises:
a fourth determination sub-module configured to determine temporal order information of a plurality of pieces of associated information and the first request information when the plurality of pieces of associated information corresponding to the first request information exist; and
a fifth determination sub-module configured to determine that the request identification result is an abnormal request when the temporal order information does not match a target temporal order.
